(19) United States
(12) Patent Application Publication
(10) Pub. No.: US 2013/0083536 A1
(43) Pub. Date: Apr. 4, 2013

(54) Optical Window in Wear Assembly

(71) Applicants: David R. Hall, Provo, UT (US); Scott Dahlgren, Alpine, UT (US)

(72) Inventors: David R. Hall, Provo, UT (US); Scott Dahlgren, Alpine, UT (US)

(21) Appl. No.: 13/252,375

(22) Filed: Oct. 4, 2011

(51) Int. Cl. F21V 33/00

(52) U.S. Cl. 362/253

(57) ABSTRACT

In one aspect of the present invention, a degradation assembly comprises a superhard material configured to degrade a formation. At least one light transparent window is disposed within the superhard material. An energy source and/or energy receiver is disposed behind the at least one light transparent window.

### BACKGROUND OF THE INVENTION

The present invention relates to optical window, which may be advantageous in a variety of applications due to their ability to transmit light. The prior art discloses such window assemblies.

U.S. Pat. No. 6,956,706 to Brandon, which is herein incorporated by reference for all that it contains, discloses an invention concerning a composite diamond window which includes a CVD diamond window pane which is mounted to a CVD diamond window frame. The frame is thicker than the pane and has a radiation transmission aperture therein across which the pane spans.

U.S. Pat. No. 6,530,539 to Goldman et al., which is herein incorporated by reference for all that it contains, discloses an interceptor missile including an infrared radiation detection subsystem and a window assembly in the hull of the missile optically coupled to the infrared radiation detection subsystem. The window assembly includes an inner window, and outer window, and a support subsystem between the inner and the outer windows defining a plurality of infrared transparent fluid flow cooling channels between the inner and outer windows. A source of fluid coupled to the cooling channels for cooling the outer window without adversely affecting the optical properties of either window.

### BRIEF SUMMARY OF THE INVENTION

In one aspect of the present invention, a degradation assembly comprises a superhard material configured to degrade a formation. At least one light transparent window is disposed within the superhard material. An energy source and/or energy receiver is disposed behind the at least one light transparent window.

The energy source may be a visible light source, an infrared light source, an x-ray source, an ultraviolet light source, a nuclear subatomic particle source, a gamma ray source, or combinations thereof, and may be configured to pulse the light signal through the light transparent window. The light source may also be configured to emit light through a process of optical amplification to produce a laser.

The energy receiver may be a visible light receiver, an infrared light receiver, an x-ray receiver, an ultraviolet light receiver, a nuclear subatomic particle source, a gamma ray receiver, or combinations thereof. The light receiver may include a scintillator, a scintillator counter, a photomultipler tube, or combinations thereof.

The light transparent window may be a natural diamond or may comprise a diamond material. The light transparent window may be substantially coaxial with a rotational axis of the assembly and may comprise an exposed end configured to be loaded against the formation. The exposed end may comprise an apex radius of curvature of 0.050 to 0.500 inches when measured from a view substantially normal to a central axis of the light transparent window. The light transparent window may be substantially isotropic and may comprise a reflective material configured to direct light. The superhard material may be sintered to the light transparent window.

The superhard material may be a polycrystalline ceramic comprising a pointed geometry and may be bonded to a fixed rotary bladed bit, a roller cone bit, a percussion bit, a horizontal drill bit, a reamer, or combinations thereof. The superhard material may also be bonded to a pick configured for attachment to a rotary drum. The superhard material may also be incorporated in other wear applications, which may use machines such as trenchers, excavators, miner, road planers, cone crushers, mulchers, jaw crushers, crushers, impactors, vertical and horizontal shaft impactors, hammer mills, and combinations thereof.

The superhard material may comprise a geometry configured to degrade the formation in a shearing failure mechanism, a compressive failure mechanism, or combinations thereof

The superhard material may be bonded to a substrate. The light transparent window or the light source and/or receiver may be at least partially disposed within an opening of the substrate.

### BRIEF DESCRIPTION OF THE DRAWINGS

FIG. 1 is a perspective view of an embodiment of a drilling operation.

FIG. 2 is a perspective view of an embodiment of a drill bit.

FIG. 3 is a cross-sectional view of an embodiment of a drill bit.

FIG. 4 is a cross-sectional view of an embodiment of a window.

FIG. 5a is a cross-sectional view of another embodiment of a window.

FIG. 5b is a cross-sectional view of another embodiment of a window.

FIG. 6a is a cross-sectional view of another embodiment of a window.

FIG. 6b is a cross-sectional view of another embodiment of a window.

FIG. 6c is a cross-sectional view of another embodiment of a window.

FIG. 7 is a cross-sectional view of another embodiment of a window.

FIG. 8a is a cross-sectional view of an embodiment of a window.

FIG. 8b is a cross-sectional view of another embodiment of a window.

FIG. 8c is a cross-sectional view of another embodiment of a window.

FIG. 8d is a cross-sectional view of another embodiment of a window.

FIG. 8e is a cross-sectional view of another embodiment of a window.

FIG. 8f is a cross-sectional view of another embodiment of a window.

FIG. 8g is a cross-sectional view of another embodiment of a window.

FIG. 8h is a cross-sectional view of another embodiment of a window.

FIG. 9 is a cross-sectional view of another embodiment of a window.

FIG. 10 is a cross-sectional view of another embodiment of a window.

FIG. 11 is a diagram of an embodiment of constituents of a degradation assembly.

FIG. 12a is a cross-sectional view of another embodiment of a window.

FIG. 12b is a cross-sectional view of another embodiment of a window.

FIG. 12c is a cross-sectional view of another embodiment of a window.

FIG. 12d is a cross-sectional view of another embodiment of a window.

FIG. 12e is a cross-sectional view of another embodiment of a window.

FIG. 12f is a cross-sectional view of another embodiment of a window.

FIG. 13a is a cross-sectional view of an embodiment of a window.

FIG. 13b is a cross-sectional view of an embodiment of a window.

FIG. 13c is a cross-sectional view of another embodiment of a window.

FIG. 13d is a cross-sectional view of another embodiment of a window.

FIG. 14a is an orthogonal view of an embodiment of a milling machine.

FIG. 14b is a cross-sectional view of an embodiment of a mining machine.

### DETAILED DESCRIPTION OF THE INVENTION AND THE PREFERRED EMBODIMENT

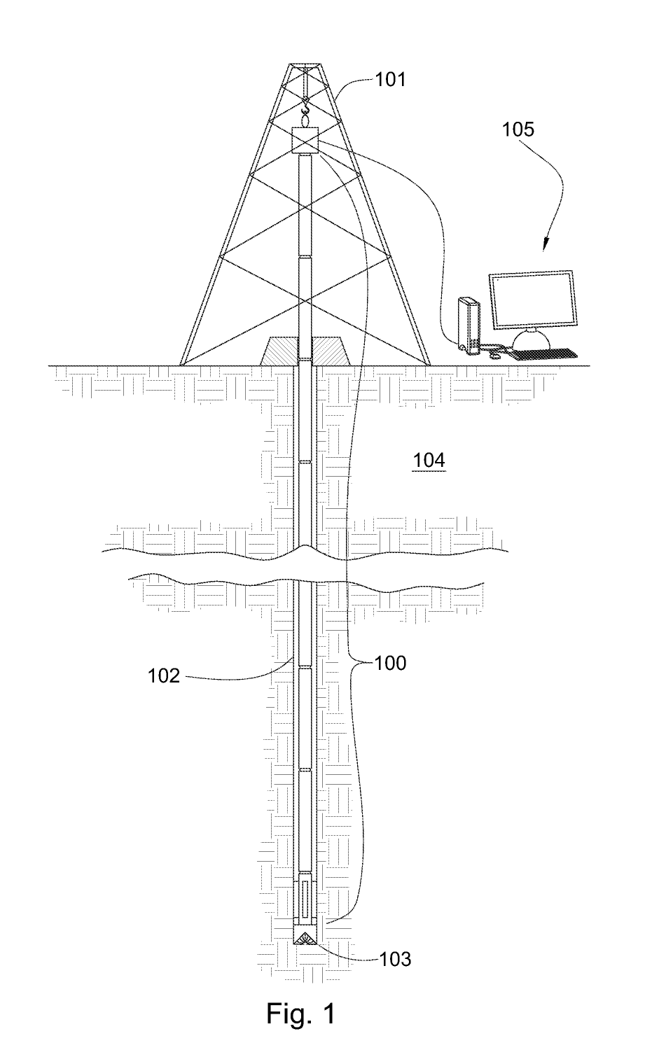

Referring now to the figures, FIG. 1 discloses a perspective view of an embodiment of a drilling operation comprising a downhole drill string 100 suspended by a derrick 101 in a borehole 102. A drill bit 103 may be located at the bottom of the borehole 102. As the drill bit 103 rotates downhole the downhole tool string 100 advances farther into the earth. The downhole tool string 100 may penetrate soft or hard subterranean formations 104. The downhole tool string 100 may comprise electronic equipment able to send signals through a data communication system to a computer or data logging system 105 located at the surface or located elsewhere within the downhole drill string 100.

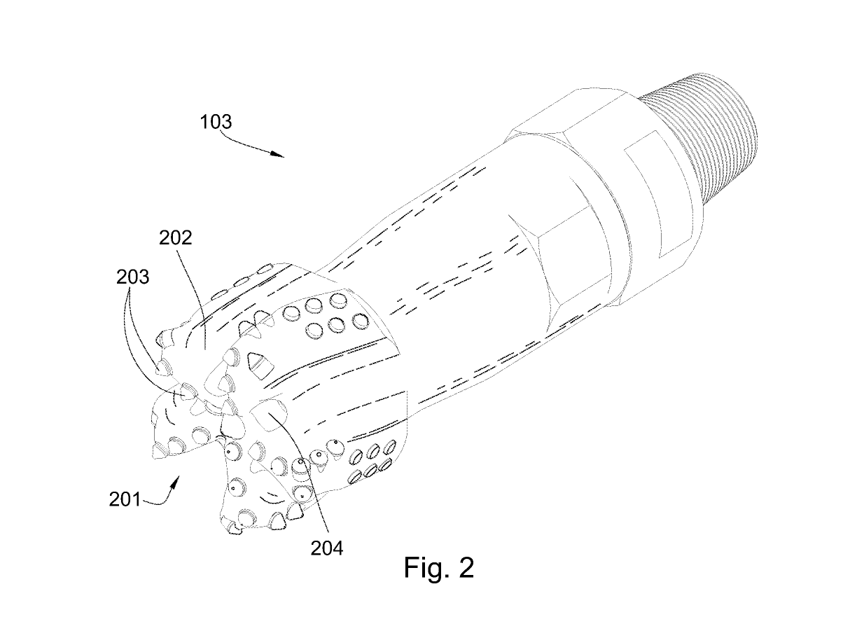

FIG. 2 discloses a drill bit 103 comprising a cutting face 201 with a plurality of blades 202 converging at the center of the cutting face 201 and diverging towards a gauge portion of the drill bit 103. The blades 202 may be equipped with a plurality of cutting elements 203 that may degrade the formation. Fluid from drill bit nozzles 204 may remove formation fragments from the bottom of the borehole and carry them up the borehole's annulus.

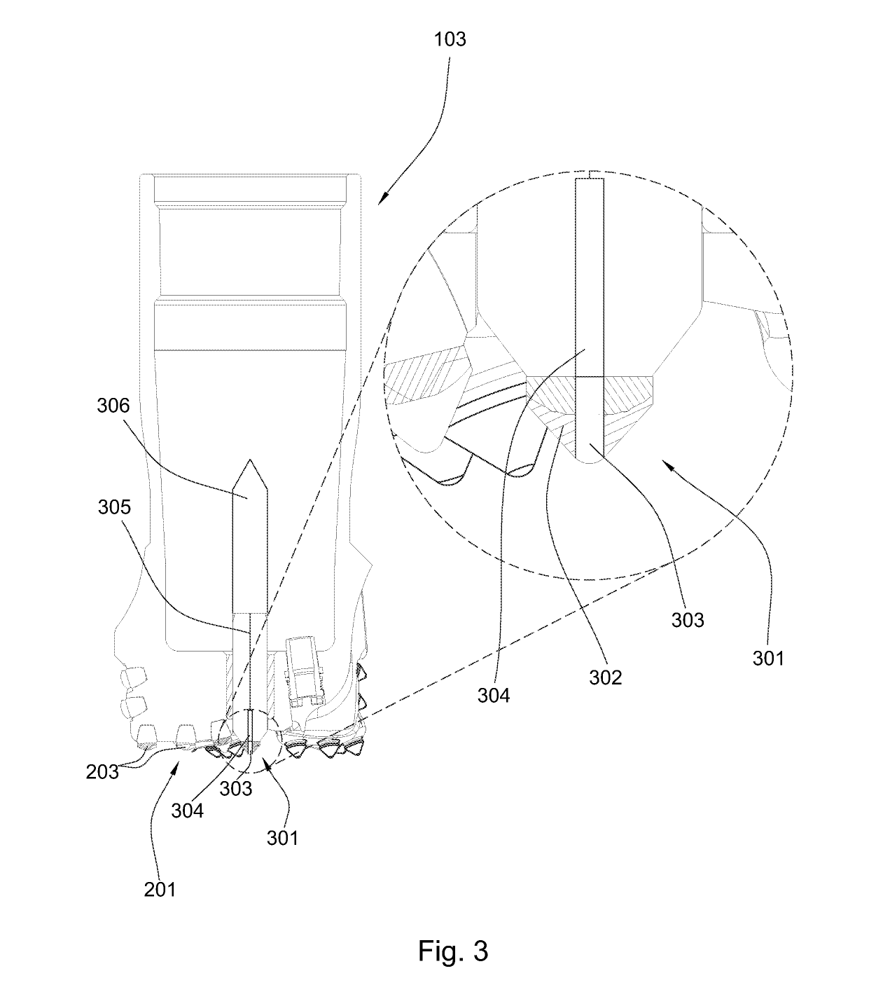

FIG. 3 discloses a cross-sectional view of the drill bit 103 with a magnified view of an indenter 301. The indenter 301 may be disposed coaxially with the rotational axis of the drill bit 103 and configured to protrude from the cutting face 201. By disposing the indenter 301 coaxial with the drill bit 103, the indenter 301 may stabilize the downhole tool string and help prevent bit whirl. The indenter 301 may also increase the drill bit's rate of penetration by focusing the tool string's weight into the formation. During normal drilling operation, the indenter 301 may be the first to come into contact with the formation and may weaken the formation before the cutting elements 203 engage the formation. In some embodiments, the indenter is placed within a cone region formed by the blades' profiles. The indenter may contact the cone formed in the bottom of the wellbore before or after other cutting elements engage the formation.

The indenter 301 may comprise a superhard material 302. The superhard material 302 may be a polycrystalline ceramic configured to degrade the formation while sustaining minimal wear, thus increasing the life of the indenter 301. Examples of suitable polycrystalline ceramics include polycrystalline diamond, sintered diamond, cubic boron nitride, or combinations thereof. At least one light transparent window 303 may be disposed within the superhard material 302, and a light source and/or light receiver 304 may be disposed behind the at least one light transparent window 303. The light source and/or light receiver 304 may be connected to an electrical wire 305 leading to downhole electronics 306. The downhole electronics 306 may be configured to communicate between tool string equipment (located in the bottom hole assembly, along the tool string, or at the surface) and the light source and/or receiver 304.

In the present embodiment, the superhard material 301 is bonded to a fixed rotary bladed bit. Other applications for which the superhard material may be bonded comprise a roller cone bit, a percussion bit, a horizontal drill bit, a reamer, or combinations thereof.

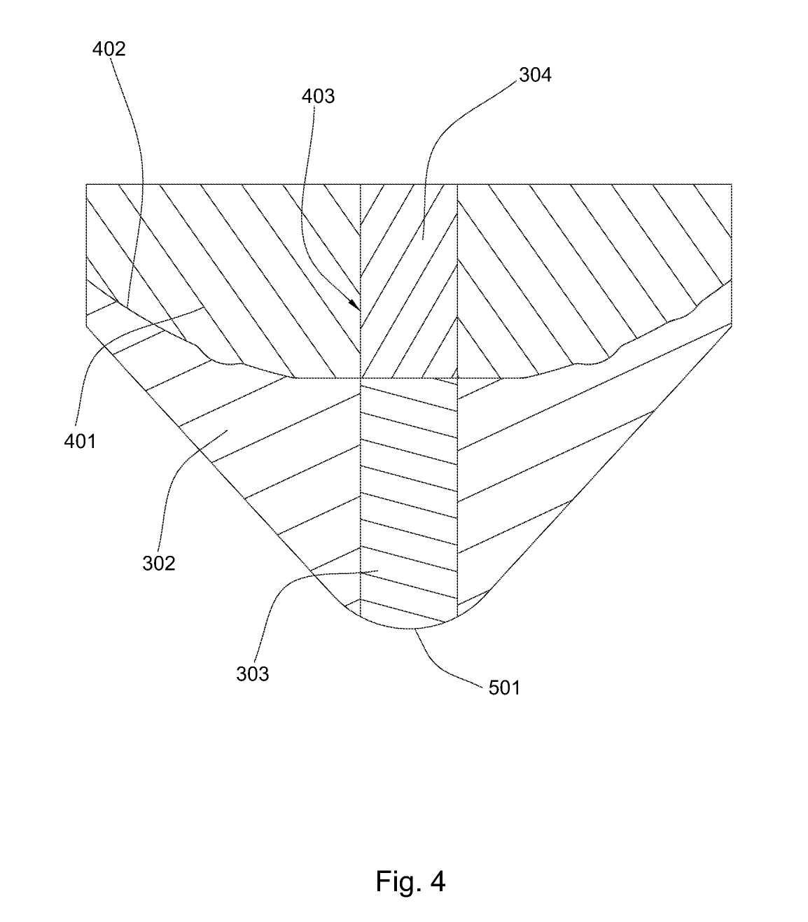

FIG. 4 discloses a cross-sectional view of an embodiment of the superhard material 302 comprising the light transparent window 303 and the energy source and/or light receiver 304. The superhard material 302 may be bonded to a substrate 401 at an interface 402 between the superhard material 302 and the substrate 401. The energy sources/receivers 304 may be a light source/receivers and/or nuclear sources/receivers. In some embodiments, the sources and receivers are part of the same assembly and in other embodiments, the sources and receivers are independent components. Some embodiments may only include sources, while other embodiments only include receivers. In some embodiments, the sources and receivers may be disposed within the substrates, while in other embodiments, the sources and receivers are disposed above the substrate. Further, the source or receiver may not be in physical contact with the windows, but may be in communication with the window through a optical or energy transparent medium, such as optical fibers, additional windows, and so forth. For example, in some embodiments, the light transparent may be made of a diamond material to withstand wear from the degradation, and a window of another material that is less suitable for wear may be placed behind the wear resistant window for communication with the receiver and/or source.

Preferably, the window 303 is made of a diamond material. Typical diamond materials used in degradation applications include sintered polycrystalline diamond that comprises sufficient catalyst to lower the energy required to cause the diamond grains to inter-grow with one another. This type of diamond material may be suitable for the superhard material that surrounds and supports the window. However, sintered polycrystalline diamond that comprises a catalyst is not transparent. The window, however, may be made of sintered polycrystalline diamond that does not require a catalyst. Such diamonds are hard to make are require much higher amounts of energy to form. However, due to the high pressure exerted on the sintered polycrystalline diamond during sintering, sintered polycrystalline diamond generally exhibits uniform properties in all directions. Thus, the sintered polycrystalline diamond is generally isotropic in its optical, thermal, and strength characteristics. Such characteristics are beneficial in embodiments, where the window comprises portions that are unsupported by the superhard material, such as embodiments, where an exposed end of the window forms a cutting edge.

Another material that may be used to form the window is a vapor deposited diamond, which may be grown in a lab such that the diamond lacks opaque material, like the metal catalyst used to form commercial available sintered diamond. Vapor deposited diamond typically grows in columns and is generally toughest along the column's length. In the present invention, a vapor deposited diamond may be used as the window and be surrounded by the sintered polycrystalline diamond that comprises the catalyst. In this manner, the sinter polycrystalline diamond may support the vapor deposited diamond and shield it from loads that are normal to the column's length.

Natural diamond may also be used as the window. While jewelry grade diamond is more optically transparent, industrial grade diamond may also be suitable. Typically, industrial grade diamond comprises impurities and occlusions that may affect the light transmitting characteristics of the window.

Each of the aforementioned windows of diamond material may be sintered to the polycrystalline diamond in a high temperature, high pressure press.

The source and/or receiver 304 may be configured to emit/receive different wavelengths within the light spectrum. The source may be a visible light source, an infrared light source, an x-ray source, an ultraviolet light source, a nuclear subatomic particle source, or combinations thereof. The receiver may be a visible light receiver, an infrared light receiver, an x-ray receiver, an ultraviolet light receiver, a nuclear subatomic particle source, or combinations thereof.

The superhard material 302 may comprise a pointed geometry; the pointed geometry may be advantageous for degrading the formation. The light transparent window 303 may be disposed within the superhard material 302, such that the light transparent window 303 may be substantially coaxial with the rotational axis of the superhard material 302.

The exposed end 501 of the window may comprise an apex radius of curvature of 0.050 to 0.500 inches when viewed from a direction substantially normal to a central axis of the light transparent window 303. A degradation element that may be compatible with the present invention is disclose in U.S. patent application Ser. Nos. 13/208,130, 11/673,634, and 12/828,287, which are incorporated by reference for all that they contain.

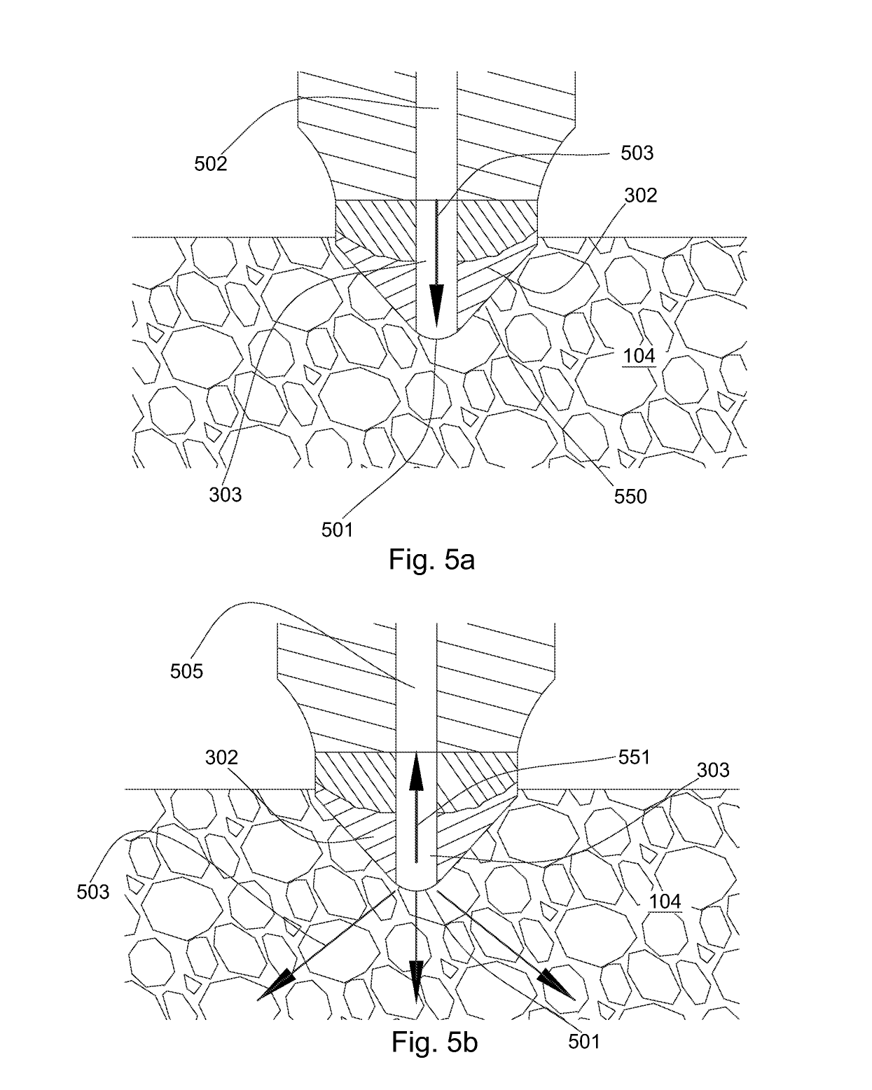

FIGS. 5a and 5b each disclose a cross-sectional view of an embodiment of the superhard material 302 penetrating the formation 104. The light transparent window 303 may comprise an exposed end 501 that is put into contact with the formation 104 as the superhard material 302 penetrates into the formation 104. In a preferred embodiment, the superhard material is disposed on the indenter, which is configured to indent into the formation and thereby fail the formation through compression. As the superhard material 302 penetrates into the formation 104, an exposed end 501 of the window may be loaded against the formation 104. Preferably, an outer profile 550 of the superhard material is compressively loaded enough against the formation 104 to seal off drilling fluid or other downhole substances from entering the crater formed by the indenter. Thus, the window 303 may be situated to take measurements of the formation 104 that are substantially unaltered by the drilling fluid or other drilling activities. These true measurements may be a significant improvement over many commercially available tools that are configured to take formation measurements that are influenced by infiltrated drilling fluid, such as along the wall of the well bore.

The energy source 502 may pulse energy through the window 303, transmit a substantially continuous supply of energy through the window 303, vary an intensity or wavelength of a continuous energy supply through the window 303, transmit a substantially consistent intensity or wavelength through the window 303, or combinations thereof. In embodiments, where the energy is pulsed, the window may receive back energy that is reflected, scattered, or otherwise redirected back into the window between the pulses. Such redirected energy may be measured by the receiver.

In the embodiment of FIGS. 5a and 5b, visible light 503 may pulsed through the light transparent window 303 to the formation 104. As the visible light 503 hits the formation 104, a portion of the light may absorb into the formation 104, and a portion of the light 551 may be reflected back through the light transparent window 303 to a light receiver 505. By analyzing the reflected light's wavelength, information about the formation 104 may relieved such as the formation's color, density, and so forth. Such information may contribute to identifying the material that the drill bit is currently drilling through. The time required to receive the reflected light 551 may also reveal additional information about the formation 104.

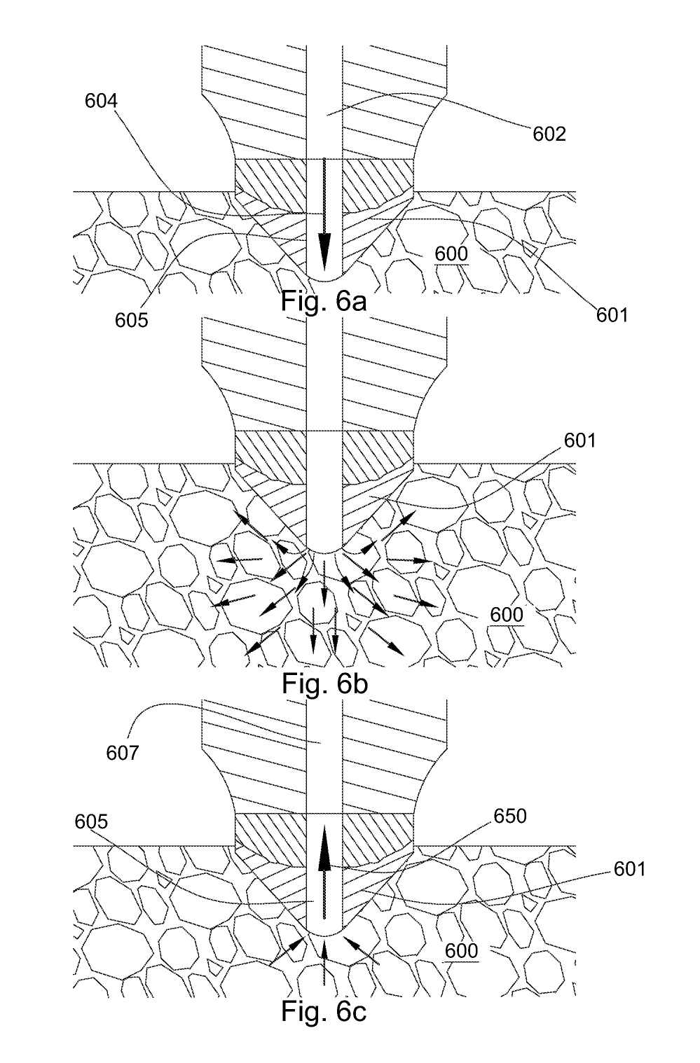

FIG. 6a discloses a superhard material 601 penetrating a formation 600. The energy source 602 may pulse infrared light 604 into the formation through the window 605. The infrared energy may be absorbed by the formation 600 as shown in FIG. 6b. The amount of infrared energy capable of being retained and/or absorbed by the formation depends on the formation's heat capacity. FIG. 6c discloses that in between pulses, some infrared energy radiating from the formation may be captured within the window. Thus, the receiver 607 may measure the intensity and/or speed at which the radiated infrared energy 650 radiated from the formation to help determine the formation's characteristics.

In an alternative embodiment, the light source may emit nuclear subatomic particles, such as gamma rays, betas, alphas, or neutrons. The subatomic particles may enter the formation and interact with molecules in the formation. Generally, the atomic interactions between the nuclear subatomic particles and the formation's atoms include collisions, absorptions, or any other interaction, which result with the formation's atoms releasing more subatomic particles, such as gamma rays, alphas, and/or betas. Thus, the subatomic particles may scatter throughout the formation resulting in some of the subatomic particles scattering back into the window towards the receiver. In some embodiments, the receiver may be configured to measure/count the gamma rays that re-enter the window, and a scintillator, scintillator counter, and/or photomultiplier may be incorporated into the receiver.

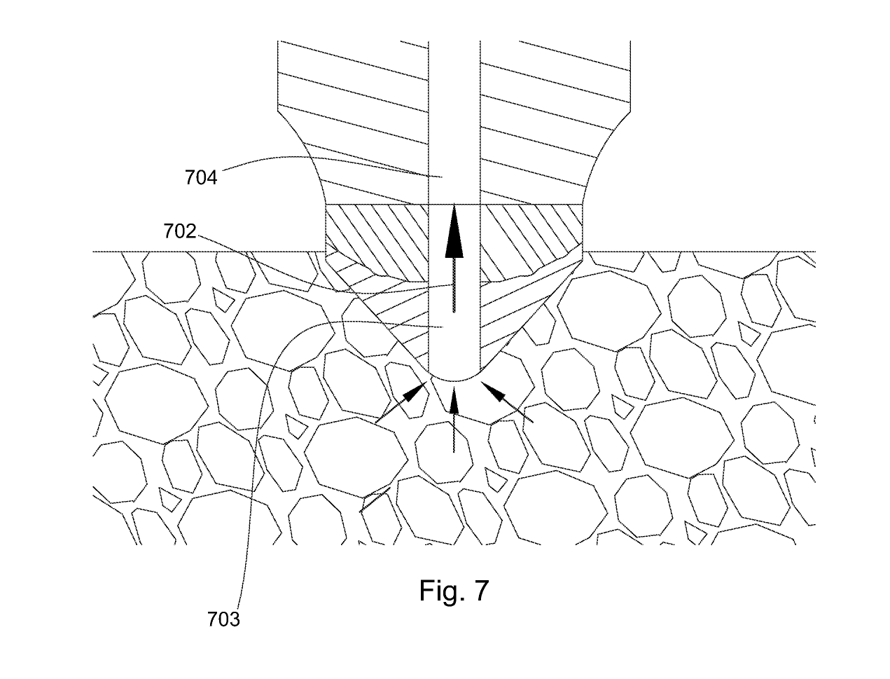

FIG. 7 discloses ambient infrared energy 702 entering the light transparent window 703. The ambient infrared energy 702 may travel through the light transparent window 703 and be received by an energy receiver 704. The amount of infrared energy radiated by the formation may be indicative of the formation's ambient temperature. Thus, a window penetrated into the formation ahead of the drill bit may allow for a passive temperature sensor to measure the formation's temperature. While the formation's temperature in oil, gas, or mineral applications may be useful, the present invention may be extremely useful in geothermal applications where heat is the primary payload.

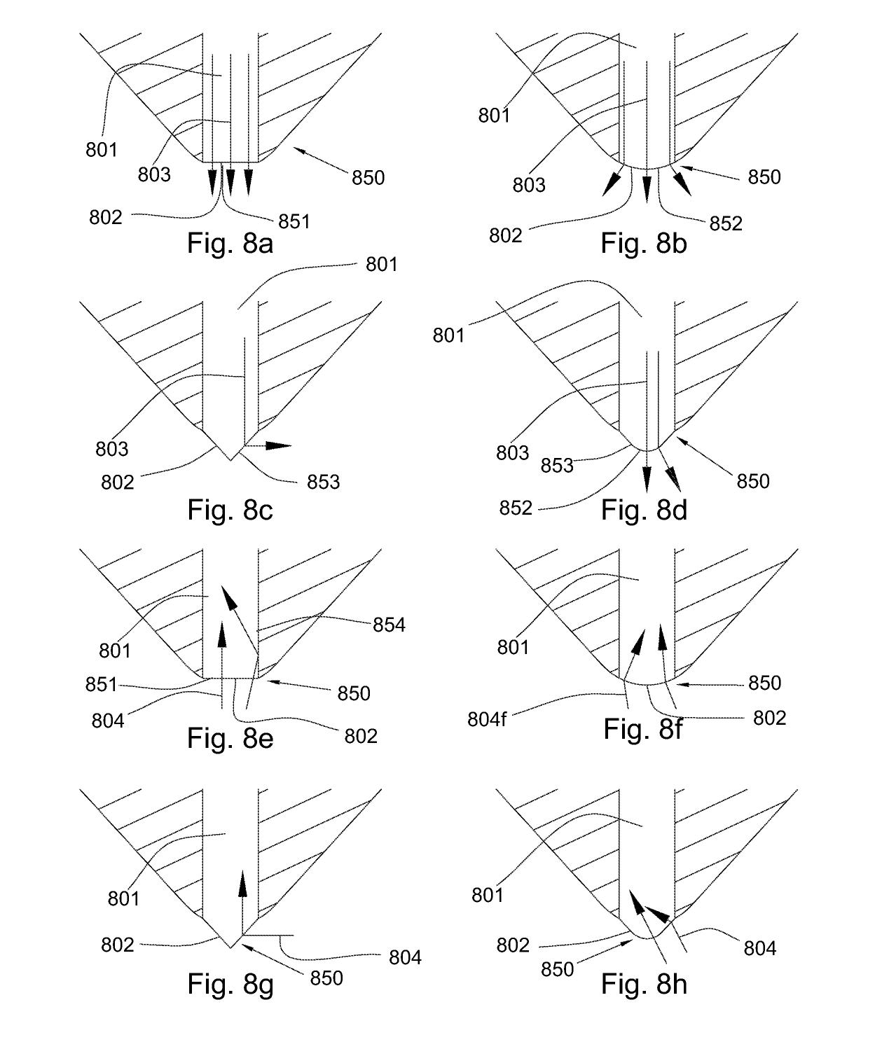

FIG. 8a through 8h each disclose embodiments of light transparent windows 801. Each light transparent window 801 may comprises an exposed end 802 that is configured to contact a formation to be degraded. Each embodiment may comprise an energy source that may emit energy 803 through the window towards the formation. The profile 850 of the exposed end 802 may affect the direction that the energy as it passes from the light transparent window 801 into a formation.

FIG. 8a discloses a profile with a flat 851. The flat 851 may generally preserve the direction of light or energy passing straight down the window. Also, in some embodiments, where the flat 851 does not protrude beyond the superhard material, the weight of the drill bit/downhole tool string will be loaded more against the superhard material. In the present embodiment, the exposed end's profile 850 and the superhard material are flush with each other, thereby sharing the weight. In some embodiments, if may be desirable that the superhard material protrude further than the window to significantly reduce and/or eliminate loads on the window.

FIG. 8b discloses a profile with a continuous curve 852. The continuous curve will increase the load on the window. In embodiments, where the window comprises a diamond material, the window may be as suitable or more suitable to handle the loads as the superhard material. Also, the curvature may disperse the light into the formation by refracting the light near the profile's periphery away from the window's central axis. However, the light traveling along the center of the window may be substantially unrefracted and focus the light immediately in front of the window and/or drill bit. Thus, a continuous curvature may guide light into the formation straight ahead and off to its periphery.

FIG. 8c discloses a substantially conical profile 853. In this embodiment, most, if not all, of the light is guided towards the window's side. Thus, little, if any light is directed straight ahead of the window.

FIG. 8d discloses a combination of the continuous curve 852 and a conical section 853. Thus, the present embodiment may share the advantages of both profiles.

FIG. 8e discloses that the profile of the exposed end also affects the windows ability to receive light and/or energy from the formation. Thus, the flat 851 may be capable of receiving light that enters at an angle that substantially normal to the exposed end's profile or light that is substantially in front of the window. Further, the embodiment of FIG. 8e also discloses that an interface 854 between the superhard material and the window may also guide the light and/or energy towards the window. Light that bounces off the interface 854 will be slower than light that enters normal to the exposed end's profile, which may affect with measurements that are intended to be time sensitive. However, measurements that are primarily intensity based may be less affected.

FIG. 8f discloses that a profile with a continuous curve may accommodate the receipt of light waves from a different range of entrance angles than a flat profile.

FIG. 8g discloses that the conical shaped profile may also accommodate different entrance angles as well, while FIG. 8h discloses a hybrid between the conical and curved profiles that may likely receive the greatest number of entrance angles.

While the exposed end's profile may affect the amount of light that enters and the direction of the light that exits the window, the window's surface finish will also affect the window's light transmission. Windows made of a diamond material may be more scratch resistant than other windows commonly incorporated into nuclear sensors. Also, in some embodiments, a significant load on the window's profile may be advantageous because the load may displace material between window and the formation. For example, any drilling mud caked onto the indenter may be swiped off from the pressure between the window and the formation. Also, water that is pooled at the bottom of the well bore may also be displaced.

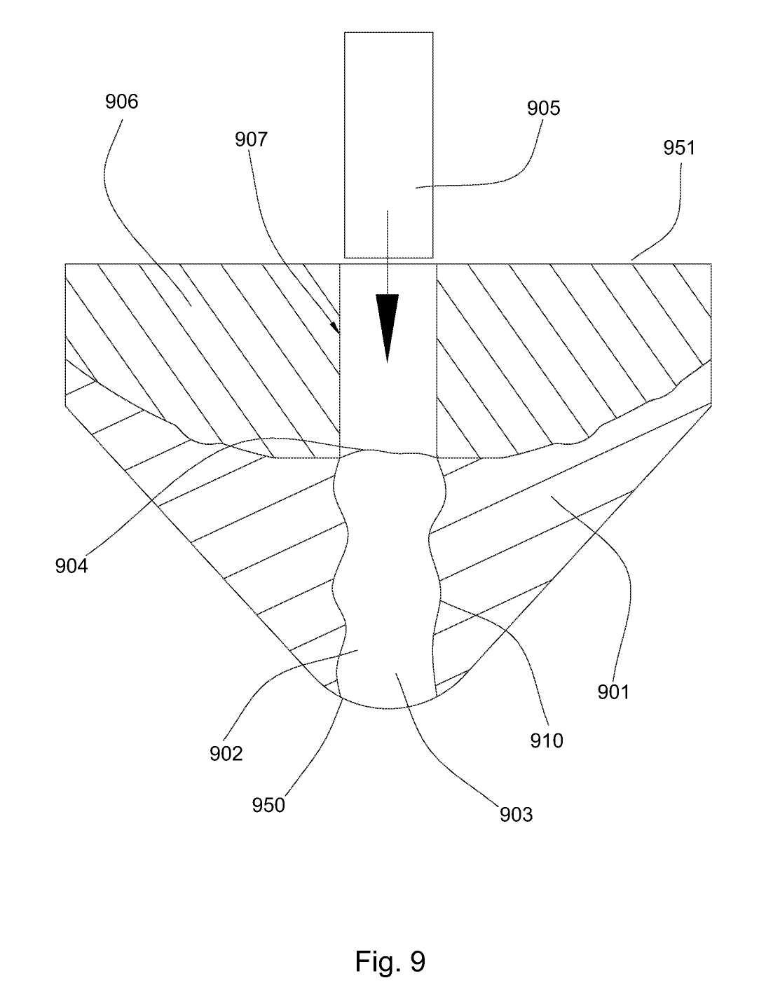

FIG. 9 discloses a superhard material 901 comprising a light transparent window 902. The light transparent window 902 may be a natural diamond 903. The natural diamond 903 may comprise non-polished length 910, which may create a stronger bond between the window 902 and the superhard material 901 during sintering. However, this non-planar interface may reflect light in multiple directions within the window, but such reflection may be suitable for some measurements.

FIG. 9 also shows the light source removed from the opening 907 in the substrate 906 between the light transparent window 902 and the source and/or receiver 905. In some embodiments, the back end of the window may not need to provide a flat interface with the source, receiver, another window, or light transmitting medium. In embodiments comprising a natural diamond, the window may comprise flaws and contain trapped gases, such as nitrogen. However, the wear benefits of a window made with a natural diamond may overcome many optical imperfections.

The source and/or receiver 905 may be at least partially disposed within an opening 907 of the substrate 906. In another embodiment, the light transparent window 902 may extend into the opening 907 as well. In other embodiments, the window spans the distance between the fore most edge 950 of the superhard material to the base of the substrate 951. In some embodiments, the window may extend beyond the substrate's base 951. Preferably, the substrates base is configured to be brazed to another surface, such as the indenter, a drill bit blade, a pick body, or other tool used in wear applications.

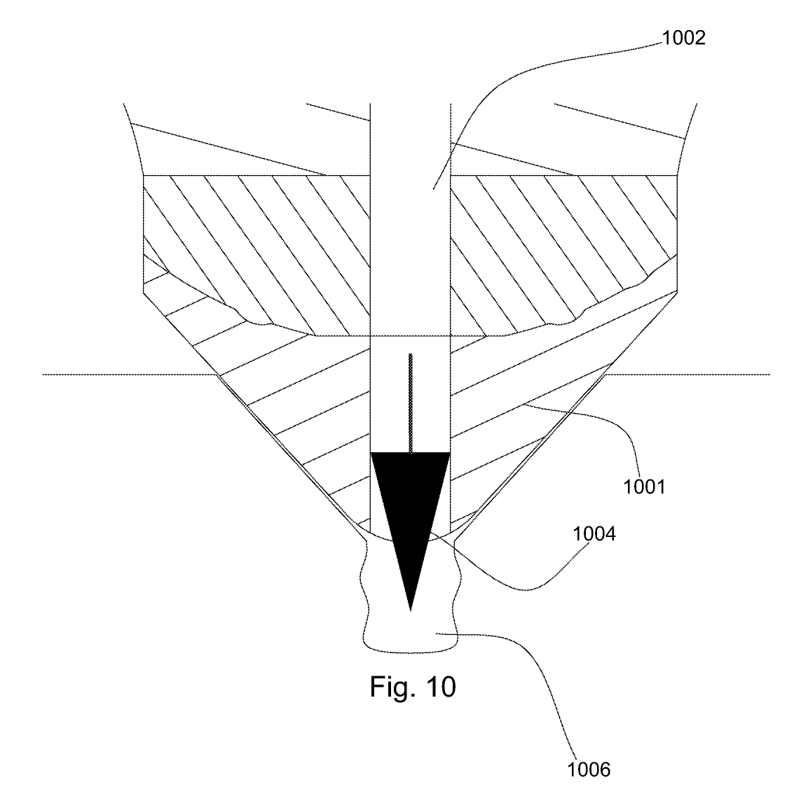

FIG. 10 discloses a light source 1002 configured to emit laser beam 1004. The light source 1002 may protrude into the superhard material 1001, which may comprise enough density to prevent energy leaks into the substrate. Although different formation types may be affected differently by the laser beam 1004, it is believed that in some formations a laser beam 1004 may vaporize a section of the formation forming a crater 1006. A crater 1006 may relieve the formation's pressure, thereby lessening the energy required to degrade it.

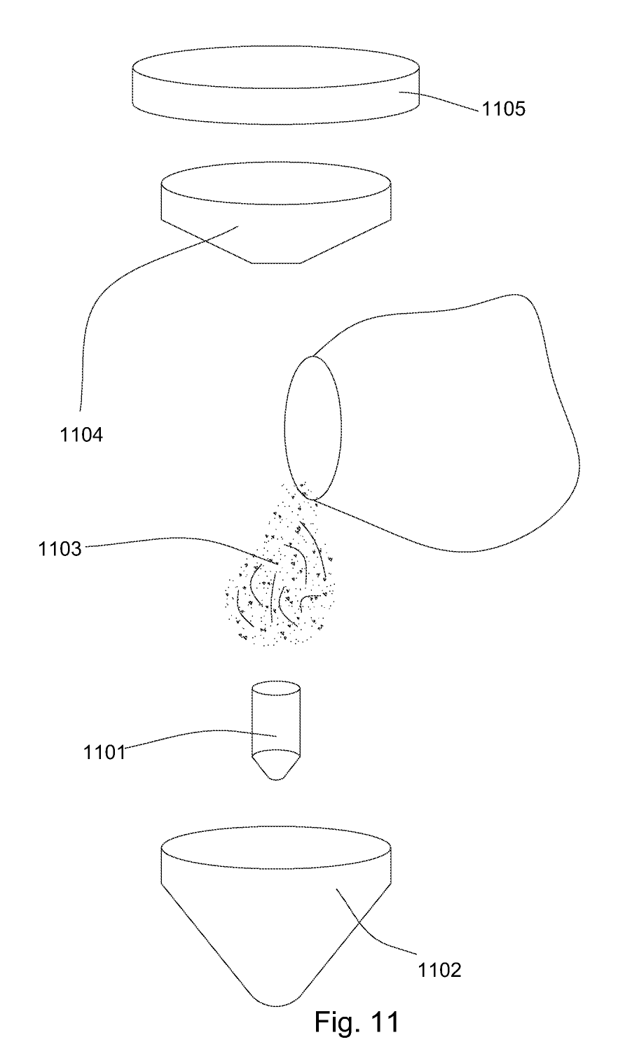

FIG. 11 discloses components that may be used to manufacture the degradation assembly. The light transparent window 1101 may be placed in a can 1102 shaped according to the desired end shape of the superhard material. The window 1101 should be arranged in the can 1102 in the desired end orientation. Diamond or cubic boron nitride powder 1103 may be packed into the can 1102 surrounding the light transparent window 1101. The powder 1103 may comprise a metal binding agent, which may catalyze the powders intergrowth during a later sintering stage. A carbide substrate 1104 may be placed over the powder 1103 and window 1101. A can lid 1105 may be placed on top of the substrate 1104. To rid the can 1102 of impurities that may interfere with sintering, the can 1102 may be sealed off while under vacuum and heat. In some embodiments, an inert gas may displace impurities within the can before sealing. After the can 1102 is sealed off, the can 1102 may be subjected to high temperatures and pressures within a specialized press. During this stage, the powder sinters together to form a superhard material. In embodiments using polycrystalline diamond as the superhard material, diamond grains in the powder bond to one another. If the window is made of a diamond material, the diamond grains may also bond to the window. The metal binder melts and fills the interstitial voids between the diamond grains. However, the metal binder will not infiltrate the window if at all due to a lack of voids within the window. Another advantage to using a diamond based window is to withstand the high temperature high pressure processing stage. After the high temperature and pressure processing, and the degradation element is removed from the can 1102. An opening may be formed into the substrate 1104 behind the window to allow a light source to come into direct contact with the light transparent window 1101.

In another embodiment, the opening may be formed in the substrate prior to high temperature high pressure processing. In this embodiments, a filler material may be packed into the opening to support the opening during sintering. The filler material may be an inert material that will fail to bond while the powder sinters together, and thus would be easy to remove. In other embodiments, the light transparent window may be configured to be disposed within the diamond powder and also fill the opening of the substrate. In such embodiments, diamond powder may be packed into the space between the window and the inner surface of the opening to accommodate for imperfect fits.

As part of the process, the light transparent window 1101 may be formed before it is placed into the can 1102. The light transparent window 1101 may be formed from a natural diamond, a polycrystalline diamond, or a chemical vapor deposition diamond. A polycrystalline diamond light transparent window may be formed in a high-pressure, high-temperature press comprising a plurality of anvils with a substantially smaller face than the anvils in the press in which the superhard material may be formed. The smaller faces of the anvils may generate higher pressures so that polycrystalline diamond powders may sinter together without the need of a metal binding agent.

A chemical vapor deposition diamond light transparent window may be grown without a metal binding agent. Although the chemical vapor deposition diamond light transparent window may be anisotropic, it is believed that the superhard material may support the diamond in the directions in which it may be inherently weaker.

In other embodiments, the light transparent window may be other transparent mediums such as transparent alumina or transparent oxides.

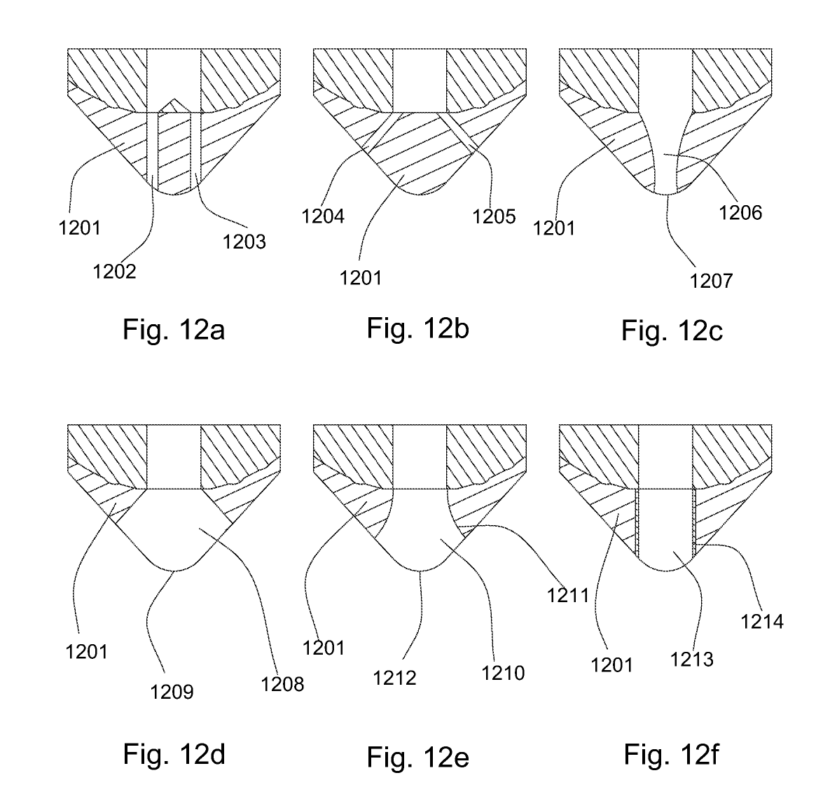

FIG. 12a discloses a first light transparent window 1202 and a second light transparent window 1203. Neither the first or second light transparent windows 1202 and 1203 may be disposed coaxial with a rotational axis of the superhard material 1201. In some embodiments, energy from a source may transmit through the first transparent window 1202 to the formation, and the redirected energy may travel through the second transparent window 1203 to the receiver. In some embodiments, additional windows are used. A primary window may be disposed coaxial within the degradation assembly. The central window may communication with the source, while peripherial windows communicate with the receiver(s).

FIG. 12b discloses a window 1204 and a window 1205 that are angled so that windows' exposed end is disposed in the degradation element's periphery.

FIG. 12c discloses a window 1206 that narrows towards the exposed end 1207. As light is transmitted by the light source through the light transparent window 1206, the narrowing profile of the window may focus the energy into a smaller cross sectional area.

FIG. 12d discloses a window 1208 that widens towards the exposed end 1209. The additional surface area of the exposed end 1209 may increase the window's capacity to receive light and/or energy.

FIG. 12e discloses a window 1210 comprising a rounded interface 1211 between the window 1210 and the superhard material 1201. Light from a formation may easily enter the window 1210 due to the enlarged exposed end 1212. The rounded interface 1211 may help guide the light to the receiver by reducing reflections from light traveling at specific angles.

FIG. 12f discloses a window 1213 comprising a peripherial reflective material 1214. The reflective material 1214 may be disposed intermediate the superhard material 1201 and the window 1213. The reflective material 1214 may be configured to confine the light within the light transparent window 1213 by internal reflection and avoid light from being absorbed into the superhard material.

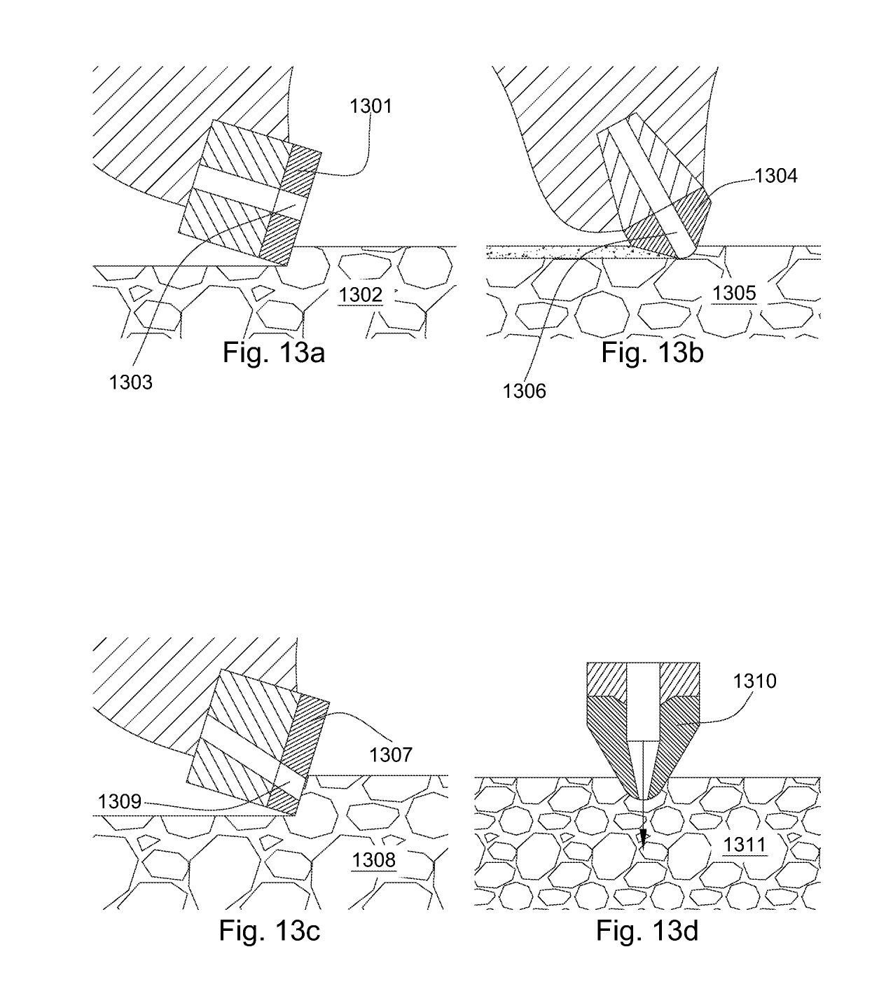

FIG. 13a discloses a degradation assembly with superhard material 1301 configured to degrade the formation 1302 by shearing. A shearing failure mechanism breaks the formation differently than the compressive mechanism described earlier. Most commercially available diamond cutters are used to degrade the formation in shear, which usually entails scrapping the formation.

In this embodiment, the window 1303 may be configured to transmit light into drilling fluid instead of into the formation. The drilling fluid, which is ejected from drill bit nozzles at the formation is configured to cool the drill bit's cutters as well as carry the cuttings away from the drill bit. The formation's cuttings are usually carried to the surface and filtered out of the drilling mud, which is recirculated through the drill string to the drill bit. For drilling fluids that comprises some optical transparency, the light from one or more windows may illuminate the fluid. Other windows located in other cutters, on the drill bit, on the bit's blade, further up the drill string, or elsewhere downhole may measure the light. The receiving windows may be positioned to directly receive a beam of light in the absence of opaque interference or the receiving light may be positioned such that the light is required to disperse through a light transmitting medium, like drilling mud that comprises some optical transparent qualities. Particles in the drilling mud, the material of the cuttings, the shape and size of the cuttings, the drilling penetration rate, and other factors may affect the amount of light received by the receiving windows.

In some embodiments, laser beams may be beneficially used where the laser beam will hit the formation ahead of the cutter.

FIG. 13b discloses a pointed degradation assembly 1304. The pointed degradation assembly 1304 may comprise a symmetric conical shape with a rounded apex. In other embodiments, a pointed degradation element may comprise an symmetric shape, a chisel shape, a pyramidal shape, or combinations thereof. A pointed degradation assembly may partially break the formation in shear; however, the apex may penetrate into the formation and break the formation by splitting the formation with the apex and pushing the formation to both sides of the cutter with its tapered section. Test results show that the pointed cutters induce deeper fractures into the formation and require less specific energy to degrade many types of formations than the shear cutters. An example of a pointed degradation element that may be used with the present invention is described in U.S. Patent Application Serial No. 2009/0051211, which is herein incorporated by reference for all that it contains.

FIG. 13c discloses superhard material 1307 degrading the formation 1308 through shear. Here, the light transparent window 1309 is configured to transmit light into the formation 1309.

FIG. 13d discloses superhard material 1310 configured to degrade a formation 1311 through a compressive failure mechanism. The superhard material 1310 may comprise chisel, rounded, and dome shaped geometries.

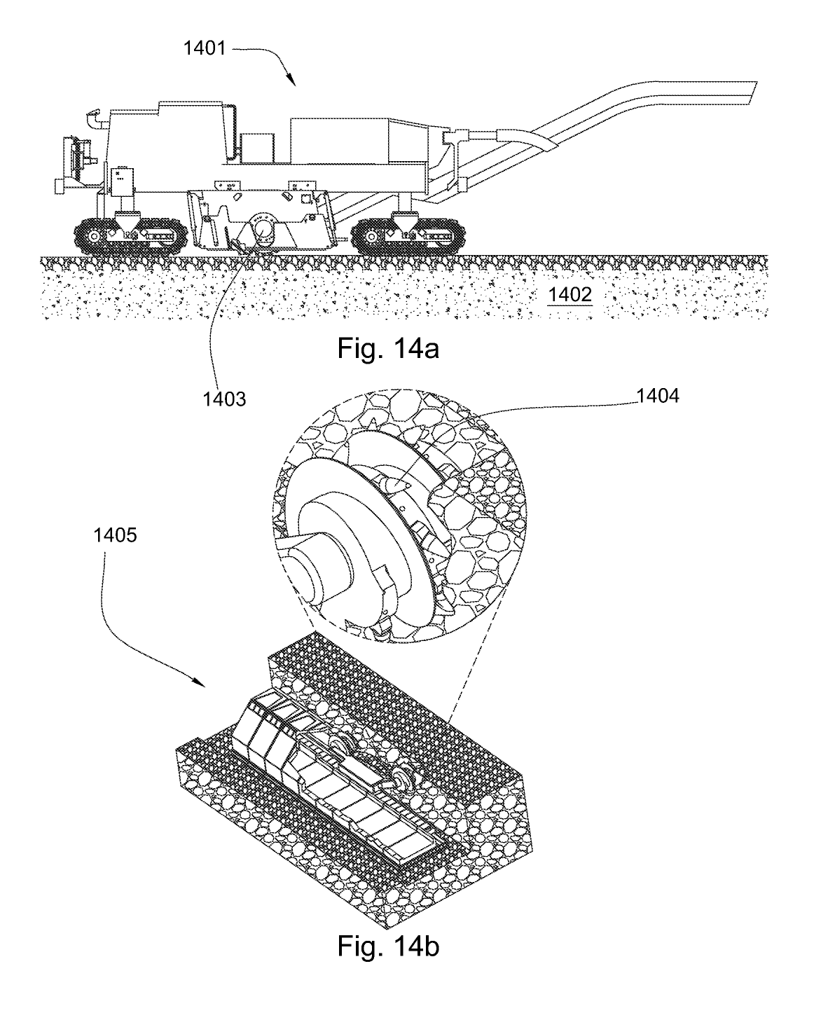

FIG. 14a discloses a milling machine 1401 that may incorporate the present invention. The milling machine 1401 may be used to degrade natural or man-made formations 1402 such as pavement, concrete, or asphalt prior to placement of a new layer. The milling machine 1401 may comprise a rotary drum 1403 comprising a plurality of picks. A superhard material comprising a light transparent window may be bonded to the these picks. Information about the formation 1402 gathered from the light transparent window may be advantageous to the milling process.

FIG. 14b discloses a long-wall mining machine 1405. The mining machine 1405 may also comprise a plurality of picks 1404 on which a superhard material comprising a light transparent window may be bonded. The present invention may also be configured for use with trenchers, hammer mills, jaw crushers, cone crushers, continuous miners, roof bolt drill bits, bucket excavators, chisels, jackhammers, bulldozers, and combinations thereof.

Whereas the present invention has been described in particular relation to the drawings attached hereto, it should be understood that other and further modifications apart from those shown or suggested herein, may be made within the scope and spirit of the present invention.

What is claimed is:

1. A degradation assembly, comprising:
a superhard material configured to degrade a formation and at least one light transparent window disposed within the superhard material; and
an energy light source and/or energy receiver disposed behind the at least one light transparent window.

2. The assembly of claim 1, wherein the energy source is a visible light source, an infrared light source, an x-ray source, an ultraviolent light source, a nuclear subatomic particle source, or combinations thereof

3. The assembly of claim 1, wherein the energy receiver is a visible light receiver, an infrared light receiver, an x-ray receiver, an ultraviolent light receiver, a nuclear subatomic particle source, or combinations thereof.

4. The assembly of claim 1, wherein the light transparent window comprises a diamond material.

5. The assembly of claim 1, wherein the superhard material is a polycrystalline ceramic.

6. The assembly of claim 1, wherein the superhard material is bonded to a fixed rotary bladed bit, a roller cone bit, a percussion bit, a horizontal drill bit, or combinations thereof

7. The assembly of claim 1, where the superhard material is bonded to a pick configured for attachment to a rotary drum.

8. The assembly of claim 1, wherein the superhard material is bonded to a substrate and the light source and/or receiver is at least partially disposed within an opening of the substrate.

9. The assembly of claim 1, wherein the superhard material is bonded to a substrate and the light transparent window is at least partially disposed within an opening of the substrate.

10. The assembly of claim 1, wherein the light transparent window is substantially coaxial with a rotational axis of the assembly.

11. The assembly of claim 1, wherein the superhard material comprises a pointed geometry.

12. The assembly of claim 1, wherein the light transparent window comprises an exposed end configured to be loaded against the formation.

13. The assembly of claim 12, wherein the exposed end comprises an apex radius of curvature of 0.050 to 0.500 inches when measured from a view substantially normal to a central axis of the light transparent window.

14. The assembly of claim 1, wherein the light transparent window is a natural diamond.

15. The assembly of claim 1, wherein the superhard material is sintered to the light transparent window.

16. The assembly of claim 1, wherein the light transparent window is substantially isotropic.

17. The assembly of claim 1, wherein the energy source is configured to pulse a signal through the light transparent window.

18. The assembly of claim 1, wherein the superhard material comprises a geometry configured to degrade the formation in a shearing failure mechanism.

19. The assembly of claim 1, wherein the superhard material comprises a geometry configured to degrade the formation through a compressive failure mechanism.
